(19) United States
(12) Patent Application Publication
(10) Pub. No.: US 2010/0019963 A1
(43) Pub. Date: Jan. 28, 2010

(54) VEHICULAR NAVIGATION AND POSITIONING SYSTEM

(75) Inventors: Jianchen Gao, Calgary (CA); Elizabeth Cannon, Calgary (CA); Mark Petovello, Calgary (CA); Kiyomi Nagamiya, Aichi (JP); Iwao Maeda, Aichi (JP); Kazunori Kagawa, Aichi (JP)

Correspondence Address: EDWARD YOO C/O BENNETT JONES, 1000 ATCO CENTRE, 10035 - 105 STREET, EDMONTON, ALBERTA, AB, T5J3T2, CA

(73) Assignees: UTI LIMITED PARTNERSHIP, Calgary, AB (CA); TOYOTA JIDOSHA KABUSHIKI KAISHA, Aichi (JP)

(21) Appl. No.: 12/304,934

(22) PCT Filed: Jun. 15, 2006
(86) PCT No.: PCT/CA06/01000

§ 371 Date: Oct. 5, 2009

(51) Int. Cl. G01S 5/14

(52) U.S. Cl. 342/357.04

(57) ABSTRACT

A vehicular navigation and positioning method and system includes a GNSS receiver, an inertial navigation system and on-board vehicular sensors. Available data is integrated by a Kalman filter and vehicle position, velocity and attitude is updated as a result.

### FIELD OF THE INVENTION

The present invention relates to a vehicular positioning system which integrates a Global Navigation Satellite System (GNSS) receiver, an inertial navigation system, and on-board vehicular sensors.

### BACKGROUND OF THE INVENTION

Vehicular navigation and positioning is one of the most important application areas for a GNSS such as the Global Positioning System (GPS). Existing GPS-based navigation systems can provide metre level accuracy or better. It is possible to achieve centimeter level accuracies by using carrier phase measurements in a double difference approach whereby the integer ambiguities are resolved correctly. GPS provides long-term, accurate and absolute positioning information but which is subject to the blockage of line-of-sight signals as well as signal interference or jamming. Additionally, its measurement update rate is relatively low, typically less than 20 Hz. This has led to the development of an integrated system whereby GPS is complemented by an inertial navigation system (INS). INS is autonomous and non-jammable, and most Inertial Measurement Unit (IMU) data rates exceed 50 Hz and some may exceed 200 Hz. However, INS navigation quality degrades with time, and its accuracy depends on the quality of INS sensors. High quality INS sensors which provide the necessary accuracy may be far too expensive for routine incorporation into vehicle manufacture.

Many modern vehicles now come equipped with an electronic stability control system, which is an active safety system that uses sensors to detect when a driver is about to lose control of the vehicle and automatically intervenes to provide stability and help the driver stay on the intended course, especially in oversteering and understeering situations. Typically, the system utilizes on-board vehicle sensors such as wheel speed sensors, a yaw rate sensor, longitudinal and latitudinal G sensors (accelerometers) as well as a steering angle sensor. These sensors provide information about velocity, accelerations, yaw rate as well as the steering angle of the vehicle.

### SUMMARY OF THE INVENTION

The present invention comprises a vehicle positioning system which uses a recursive filter for estimating the state of a dynamic system, such as a Kalman filter, to integrate data from a GNSS receiver, INS data, and vehicle sensor data. A Kalman filter is a set of mathematical equations that provides an efficient computational (recursive) means to estimate the state of a process, in a way that minimizes the mean of the squared error.

Therefore, in one aspect, the invention may comprise a method of estimating one or more of the velocity, position, or attitude of a vehicle equipped with a GNSS receiver, an inertial navigation system (INS), a vehicle sensor comprising a steering angle sensor and optionally a wheel speed sensor, a yaw rate sensor, and/or two G sensors (accelerometers), comprising the steps of:

(a) setting one or more of an initial velocity, position or attitude;

(b) periodically obtaining INS data, vehicle sensor data, and if GNSS data is available, GNSS data from the GNSS receiver;

(c) in a recursive estimation filter, integrating all available data and estimating one or more error states including one or more of position error, velocity error, attitude error, IMU sensor error, vehicle sensor error and GNSS ambiguity; and

(d) updating one or more of the vehicle position, velocity or attitude.

The G sensors may be orthogonal accelerometers whose data, if necessary, can be rotated into longitudinal and latitudinal directions.

In one embodiment, the recursive estimation filter is a Kalman filter. The Kalman filter may be configured as a single master filter in a centralized approach. All available sensor data, INS data, and GNSS data are utilized to obtain a globally optimum solution. In an alternative embodiment, a two-stage distributed configuration uses local sensor-related filters, which output to and are combined by a larger master filter, in a decentralized or federated filter.

In one embodiment, the GNSS is a GPS system.

In a preferred embodiment, a centralized Kalman filter or tight coupling strategy is used to augment a GPS/INS integrated system with on-board vehicle sensors. Four basic integration strategies are provided. The integration of the wheel speed sensors, the yaw rate sensor, two G sensors plus yaw rate sensor as well as the steering angle sensor with GPS/INS can provide measurement updates such as absolute velocity, relative azimuth angle, two dimensional position and velocity, as well as the steering angle respectively. The wheel speed sensor scale factor, the yaw rate sensor bias, the G sensor bias, the steering angle sensor's scale factor and bias, as well as the misalignment angles between IMU body frame and vehicle frame are appropriately modelled as error states and estimated on-line by the centralized Kalman filter. The benefits of integrating the on-board vehicle sensors include the increase in system redundancy and reliability, the improvement on the positioning accuracy during GPS outages, and the reduction of the time to fix ambiguities after GPS outages.

In one embodiment, the integration step comprises the step of integrating steering angle data which provides the tire angle relative to its neutral position, and one or more of the group comprising:

(a) integrating velocity data derived from the at least one wheel speed sensor;

(b) integrating azimuth angle data derived from the yaw rate sensor;

(c) integrating position and velocity data derived from the at least two G sensors and the yaw rate sensor.

In another aspect, the invention comprises a system for estimating the velocity, position, or attitude of a vehicle equipped with a GNSS receiver, an inertial navigation system (INS), a vehicle sensor comprising a steering angle sensor and optionally a wheel speed sensor, a yaw rate sensor, and/or at least two G sensors, comprising:

(a) means for setting one or more of an initial velocity, position or attitude;

(b) means for periodically obtaining INS data, vehicle sensor data, and if GNSS data is available, GNSS data from the GNSS receiver;

(c) a recursive estimation filter for integrating all available data and estimating one or more error states including one or more of position error, velocity error, attitude error, IMU sensor error, vehicle sensor error and GNSS ambiguity; and

(d) means for updating one or more of the vehicle position, velocity or attitude.

In one embodiment, the recursive estimation filter comprises a module for integrating steering angle data which provides the tire angle relative to its neutral position, and one or more of the group comprising:

(a) a module for integrating velocity data derived from the at least one wheel speed sensor;

(b) a module for integrating azimuth angle data derived from the yaw rate sensor; and

(c) a module for integrating position and velocity data derived from the at least two G sensors and the yaw rate sensor.

### BRIEF DESCRIPTION OF THE DRAWINGS

The invention will now be described by way of an exemplary embodiment with reference to the accompanying drawings.

FIG. 1 shows the strategy of integrating GPS/INS, two orthogonal G sensors (GL1 and GL2), and the yaw rate sensor.

FIG. 2 shows the relative orientation of the GL1 and GL2 sensors.

FIG. 3 shows the strategy of integrating GPS/INS and the wheel speed sensor.

FIG. 4 shows the rear and front wheel side slip angles.

FIG. 5 shows the strategy of integrating GPS/INS and the yaw rate sensor.

FIG. 6 shows the strategy of integrating GPS/INS and the steering angle sensor.

FIG. 7 shows the geometry between the velocity and the steering angle.

FIG. 8 shows a schematic depiction of integrating the basic integration modules and combined integration modules.

FIG. 9 shows a flowchart of one implementation of an integration strategy.

### DETAILED DESCRIPTION OF THE INVENTION

The present invention provides for a system and method of vehicular positioning, which integrates a Global Navigation Satellite System (GNSS) receiver, an inertial navigation system (INS), and on-board vehicular sensors. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

GNSS is a term which refers generally to satellite-based navigation systems. The best-known GNSS is GPS. Reference herein to GPS may also include other satellite navigation systems which may be implemented or become available in the future, such as GLONASS or Galileo.

Reliable and fast ambiguity resolution is very important in high-accuracy GPS applications. The search volume of ambiguity resolution has a close relationship with the ambiguity resolution speed. An external measurement update such as an inertial measurement can reduce the covariance of the estimated ambiguities and, as a result, some benefits can be gained in the time to fix ambiguities after GPS outages (Scherzinger (2002), Petovello (2003) as well as Zhang et al. (2005)). In the present invention, an additional external measurement provided by on-board vehicle sensors and particularly the steering angle sensor is provided. As a result, the ambiguity search volume as well as time to fix ambiguities maybe reduced when integrating the on-board vehicle sensors with GPS and INS.

The GPS, INS and on-board sensors may be coupled tightly or loosely. According to the coupling relationship between the local sensors and the filtering technique, Kalman filtering for integrated systems is usually implemented in one of three different ways—centralized, decentralized and federated, any one of which may be suitable for implementation in the present invention. Each kind of filter has its advantages and disadvantages, and a specific filter may be chosen by one skilled in the art for a specific application based on those advantages and disadvantages.

In one example, a tight coupling strategy with a centralized extended Kalman filter is used to tightly couple GPS, INS and on-board vehicle sensors. Alternative embodiments may use decentralized or federated Kalman filters, as is well-known in the art. In the present invention, GPS and INS are integrated with on-board vehicle sensors which may include one or more wheel speed sensors (WSS), a yaw rate sensor (YRS), two G sensors (GL1 and GL2), and a steering angle sensor (SAS). Each on-board vehicle sensor or a combination of different sensors may be integrated into a GPS/INS system by using one or more of four different basic integration modules. The two G sensors may be oriented longitudinally and laterally in the vehicle, or may be orthogonal in any orientation, and can be rotated into longitudinal and latitudinal directions if necessary.

One module integrates GL1/GL2 data and yaw rate data, providing two dimensional position and velocity update. Another integration module integrates wheel speed sensor data providing absolute velocity update for the GPS/INS centralized Kalman filter. Yet another module integrates yaw rate sensor data, providing relative azimuth angle update. A final module integrates steering angle sensor data, providing a steering angle update by deriving the estimated steering angle measurement through the velocity in vehicle frame.

Based on these four basic integration modules, other combined integration strategies can be derived. These combined integration strategies may include, but are not limited to:
GPS/INS/YRS/WSS,
GPS/INS/GL1/GL2/YRS/WSS,
GPS/INS/SAS/WSS,
GPS/INS/SAS/GL1/GL2/YRS/WSS
GPS/INS/SAS/YRS.

The steering angle sensor is a preferred sensor in the present invention, as the steering angle of the vehicle provides the tire angle relative to its neutral position, which can be used as a horizontal velocity constraint without reliance on G sensors or yaw rate sensor data.

The wheel speed sensor scale factor, the yaw rate sensor bias, the GL1 and GL2 sensor biases, the steering angle sensor scale factor and bias, as well as the misalignment angles between IMU body frame and vehicle frame may be appropriately modelled and estimated by the centralized Kalman filter.

Although the integration of different vehicle sensors requires different algorithms based on the type of data provided by the sensor, each integration module shares certain basic strategies and components.

Four coordinate frames are used in one embodiment of this invention. They are the IMU body frame, vehicle frame, ECEF frame and local level frame. The coordinate frames may be modified or defined differently, and the transformations between such frames are well-known to those skilled in the art. The origin of the ECEF frame (e-frame) is the center of the Earth's mass. The X-axis is located in the equatorial plane and points towards the mean Meridian of Greenwich. The Y-axis is also located in the equatorial plane and is 90 degrees east of the mean Meridian of Greenwich. The Z-axis parallels the Earth's mean spin axis.

The IMU body frame (b-frame) represents the orientation of the IMU axes. The IMU sensitive axes are assumed to be approximately coincident with the moving platform upon which the IMU sensors are mounted. In the body frame, the origin is the centre of IMU, the X-axis points towards the right of the moving platform upon which the IMU sensors are mounted, the Y-axis points towards the front of moving platform upon which the IMU sensors are mounted, and the Z-axis is orthogonal to the X and Y axes to complete the right-handed frame.

The vehicle frame (v-frame) is actually the vehicle body frame, and represents the orientation of the vehicle. The origin is the gravity centre of the vehicle, the X-axis points towards the right side of the vehicle, the Y-axis points towards the forward direction of the vehicle motion, and the Z-axis is orthogonal to the X and Y axes to complete the right-handed frame.

The local-level frame is centered at the user's location with the X-axis pointing east in the horizontal plane, the Y-axis pointing north in the horizontal plane and the Z-axis pointing upwards.

In an ideal case the body and vehicle frames are aligned. However, due to installation errors of the IMU, the bore sight of IMU is typically misaligned with vehicle frame in most cases. It is therefore preferable to calibrate the misalignment, or tilt, angles between the body and vehicle frames.

In one embodiment, it is preferable to know the measurement accuracy of the on-board sensors when integrating with GPS and INS. Static data processing may be used to assess the GL1, GL2 and yaw rate sensors. The yaw rate sensor will measure the Earth's rotation. The output of the G sensors will also theoretically be zero if they are assumed to be aligned with the horizontal plane. Practically, the static output of these on-board vehicle sensors can be used to assess their measurement accuracy or the error variability. However, when the vehicle is stationary, the outputs of the wheel speed sensors will be theoretically zero. Static tests are not valid in this instance. Wheel speed sensor accuracy can be assessed in a kinematic test with a GPS receiver, which can provide mm/s accuracy. Measurement variance of the steering angle sensor is also difficult to estimate in a static test, and may be determined empirically through testing various test scenarios in the Kalman filter. Average standard deviations and average variance for each of the sensors may be derived and used in the integration strategies described herein.

### GPS/INS/GL1/GL1/YAW Rate Sensor Integration Strategy And Algorithm

The error states estimated by the GPS/INS centralized Kalman filter include, but are not limited to, position error, velocity error, misalignment angles, accelerometer and gyro biases. All these error states are three-dimensional. Because the GPS/INS system is tightly coupled in this embodiment, the double differenced ambiguities are also contained in the error states, when necessary. The dynamic model for GPS/INS centralized Kalman filter is expressed in equation (1)

$$\begin{matrix}[ \begin{matrix}δ {\dot{r}}^{e} \\ δ {\dot{v}}^{e} \\ {\dot{ɛ}}^{e} \\ δ {\dot{b}}^{b} \\ δ {\dot{d}}^{b} \\ Δ ∇ \dot{N}\end{matrix} ] = [ \begin{matrix}0 & I & 0 & 0 & 0 & 0 \\ {N}^{e} & - 2 {Ω}_{ie}^{e} & - {F}^{e} & {R}_{b}^{e} & 0 & 0 \\ 0 & 0 & - {Ω}_{ie}^{e} & 0 & {R}_{b}^{e} & 0 \\ 0 & 0 & 0 & - diag ( {α}_{i} ) & 0 & 0 \\ 0 & 0 & 0 & 0 & - diag ( {β}_{i} ) & 0 \\ 0 & 0 & 0 & 0 & 0 & 0\end{matrix} ] \cdot \\ [ \begin{matrix}δ {r}^{e} \\ δ {v}^{e} \\ {ɛ}^{e} \\ δ {b}^{b} \\ δ {d}^{b} \\ Δ ∇ N\end{matrix} ] + [ \begin{matrix}0 & 0 & 0 & 0 \\ {R}_{b}^{e} & 0 & 0 & 0 \\ 0 & {R}_{b}^{e} & 0 & 0 \\ 0 & 0 & I & 0 \\ 0 & 0 & 0 & I \\ 0 & 0 & 0 & 0\end{matrix} ] \cdot [ \begin{matrix}{w}_{f} \\ {w}_{w} \\ {w}_{b} \\ {w}_{d}\end{matrix} ] \\ = {F}_{GPS / INS} \cdot δ x + G \cdot w\end{matrix} \qquad ( 1 )$$

where

δr^{e} is the position error vector

δv^{e} is the velocity error vector

ε^{e} is the misalignment angle error vector

w_{f} is the accelerometer noise

w_{w} is the gyro noise

δb^{b} is the vector of the accelerometer bias errors

δd^{b} is the vector of the gyro bias errors

diag(αᵢ) is diagonal matrix of time constants for the accelerometer bias models

diag(βᵢ) is diagonal matrix of time constants for the gyro bias models

w_{b} is the driving noise for the accelerometer biases

w_{d} is the driving noise for the gyro biases

Δ∇N is the vector of double difference carrier phase ambiguities,

F^{e} is the skew-symmetric matrix of specific force in the e frame

N^{e} is the tensor of the gravity gradients

Ωᵢₑ^{e} is the skew-symmetric matrix of the Earth rotation rate with respect to the e frame

R_{b}^{e} is the direction cosine matrix between b frame and e frame

δx is the vector of error states,

F_{GPS/INS} is the dynamic matrix for GPS/INS integration strategy, and

G is the shaping matrix for the driving noise

As implied by the above model, in a preferred embodiment, the bias states are modeled as first-order Gauss-Markov processes.

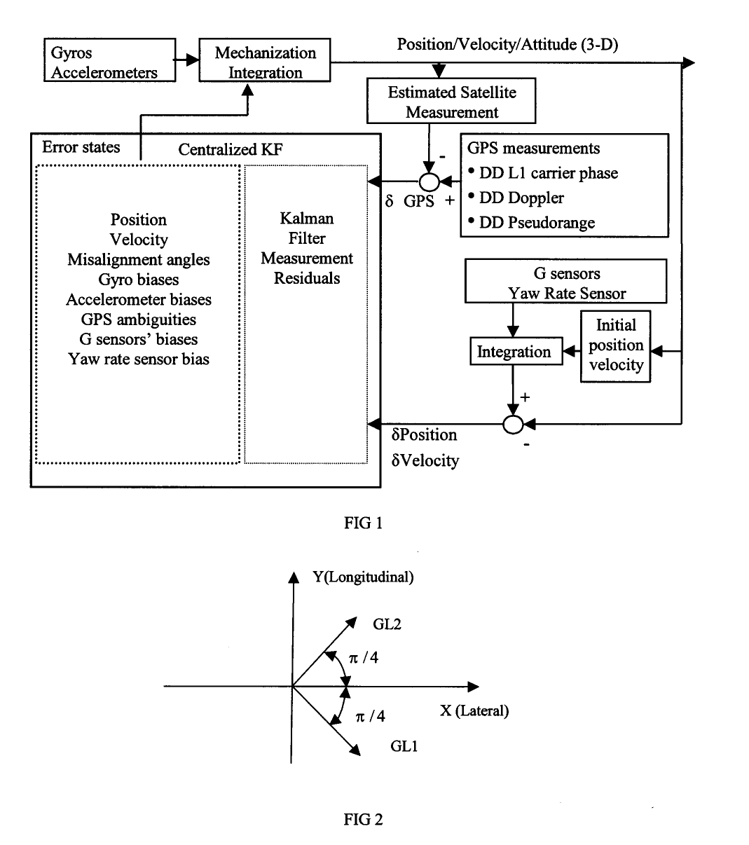

FIG. 1 shows the integration strategy for the GPS, INS, GL1, GL2 and yaw rate sensors. Two dimensional position and velocity can be obtained from the GL1, GL2 and yaw rate sensor mechanization equation, which therefore can be applied to update the GPS/INS Kalman filter. The initial values in the GL1/GL2/Yaw rate mechanization equation are given by the integrated output. FIG. 2 shows the location of GL1 and GL2 sensors with reference to the lateral and the longitudinal directions of the vehicle frame. GL1 and GL2 are oriented 45 degrees offset with respect to the lateral and longitudinal directions of the vehicle frame. To derive the position and velocity from the GL1, GL2 and the yaw rate sensors, the first step is to compute the specific force in the lateral (X) and the longitudinal (Y) directions of the vehicle frame from the GL1 and GL2 measurements. However, if the G sensors are placed along the longitudinal and lateral directions in some other applications, this step can be skipped. Assuming the G sensors are horizontally placed in the vehicle frame without any tilted angles, the specific forces in the lateral and longitudinal directions are computed by equation (2)

$$\{ \begin{matrix}{f}_{x}^{v} = ( {G}_{L 1} + {G}_{L 2} ) \cdot cos ( π / 4 ) = ( \begin{matrix}{\hat{G}}_{L 1} + {\hat{G}}_{L 1} + \\ {b}_{GL 1} + {b}_{GL 2}\end{matrix} ) \cdot cos ( π / 4 ) \\ {f}_{y}^{v} = ( {G}_{L 2} - {G}_{L 1} ) \cdot cos ( π / 4 ) = ( \begin{matrix}{\hat{G}}_{L 2} - {\hat{G}}_{L 1} + \\ {b}_{GL 2} - {b}_{GL 1}\end{matrix} ) \cdot cos ( π / 4 )\end{matrix} \qquad ( 2 )$$

where b_{GL1} is the bias of the GL1 sensor and b_{GL2} is the bias of the GL2 sensor.
Equation (3) expresses the relationship between acceleration, specific force and the yaw rate in the vehicle frame with gravity being taking into account (Hong, 2003; Dissannayake et al., 2001):

$$\{ \begin{matrix}{\dot{V}}_{x}^{v} = {f}_{x}^{v} - {V}_{y}^{v} \cdot γ + {g}_{x}^{v} \\ {\dot{V}}_{y}^{v} = {f}_{y}^{v} - {V}_{x}^{v} \cdot γ + {g}_{y}^{v} \\ {\dot{V}}_{z}^{v} = {g}_{x}^{v}\end{matrix} \qquad ( 3 )$$

where γ is the yaw rate sensor measurement and g is the gravity vector Transforming equation (3) from the vehicle frame to the ECEF frame to obtain Equation (4) gives

$$[ \begin{matrix}{\dot{V}}_{x}^{e} \\ {\dot{V}}_{y}^{e} \\ {\dot{V}}_{z}^{e}\end{matrix} ] = {R}_{v}^{e} [ \begin{matrix}\begin{matrix}{f}_{x}^{v} \\ {f}_{y}^{v}\end{matrix} \\ 0\end{matrix} ] + {R}_{v}^{e} [ \begin{matrix}0 & - 1 & 0 \\ 1 & 0 & 0 \\ 0 & 0 & 0\end{matrix} ] \cdot {( {R}_{v}^{e} )}^{T} [ \begin{matrix}{V}_{x}^{e} \\ {V}_{y}^{e} \\ {V}_{z}^{e}\end{matrix} ] \cdot γ + [ \begin{matrix}\begin{matrix}{g}_{x}^{e} \\ {g}_{y}^{e}\end{matrix} \\ {g}_{z}^{e}\end{matrix} ] \qquad ( 4 )$$

### Assuming

$$\begin{matrix}{R}_{v}^{e} = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] & ( 5 ) \\ {R}_{y} = {R}_{v}^{e} [ \begin{matrix}0 & - 1 & 0 \\ 1 & 0 & 0 \\ 0 & 0 & 0\end{matrix} ] \cdot {( {R}_{v}^{e} )}^{T} = [ \begin{matrix}{R}_{y 11} & {R}_{y 12} & {R}_{y 13} \\ {R}_{y 21} & {R}_{y 22} & {R}_{y 23} \\ {R}_{y 31} & {R}_{y 32} & {R}_{y 33}\end{matrix} ] & ( 6 )\end{matrix}$$

and substituting equations (5) and (6) into equation (4), the state space equation for the position and velocity in the ECEF frame is expressed in Equation (7)

$$\{ \begin{matrix}{\dot{r}}_{x}^{e} = {V}_{x}^{e} \\ {\dot{r}}_{y}^{e} = {V}_{y}^{e} \\ {\dot{r}}_{z}^{e} = {V}_{z}^{e} \\ \begin{matrix}{\dot{V}}_{x}^{e} = [ \begin{matrix}( {R}_{11} - {R}_{12} ) {G}_{G L 1} + \\ ( {R}_{11} + {R}_{12} ) {G}_{L 2}\end{matrix} ] cos ( π / 4 ) + ( \begin{matrix}{Ry}_{11} {V}_{x}^{e} + \\ {Ry}_{12} {V}_{y}^{e} + \\ {Ry}_{13} {V}_{z}^{e}\end{matrix} ) \cdot γ + \\ [ \begin{matrix}( {R}_{11} - {R}_{12} ) {b}_{L 1} + \\ ( {R}_{11} + {R}_{12} ) {b}_{GL 2}\end{matrix} ] cos ( π / 4 ) + ( \begin{matrix}{Ry}_{11} {V}_{x}^{e} + \\ {Ry}_{12} {V}_{y}^{e} + \\ {Ry}_{13} {V}_{z}^{e}\end{matrix} ) \cdot {d}_{Yaw} + {g}_{x}^{e}\end{matrix} \\ \begin{matrix}{\dot{V}}_{y}^{e} = [ \begin{matrix}( {R}_{21} - {R}_{22} ) {G}_{L 1} + \\ ( {R}_{21} + {R}_{22} ) {G}_{L 2}\end{matrix} ] cos ( π / 4 ) + ( \begin{matrix}{Ry}_{21} {V}_{x}^{e} + \\ {Ry}_{22} {V}_{y}^{e} + \\ {Ry}_{23} {V}_{z}^{e}\end{matrix} ) \cdot γ + \\ [ \begin{matrix}( {R}_{21} - {R}_{22} ) {b}_{GL 1} + \\ ( {R}_{21} + {R}_{22} ) {b}_{GL 2}\end{matrix} ] cos ( π / 4 ) + ( \begin{matrix}{Ry}_{21} {V}_{x}^{e} + \\ {Ry}_{22} {V}_{y}^{e} + \\ {Ry}_{23} {V}_{z}^{e}\end{matrix} ) \cdot {d}_{Yaw} + {g}_{y}^{e}\end{matrix} \\ \begin{matrix}{\dot{V}}_{z}^{e} = [ \begin{matrix}( {R}_{31} - {R}_{32} ) {G}_{L 1} + \\ ( {R}_{31} + {R}_{32} ) {G}_{L 2}\end{matrix} ] cos ( π / 4 ) + ( \begin{matrix}{Ry}_{31} {V}_{x}^{e} + \\ {Ry}_{32} {V}_{y}^{e} + \\ {Ry}_{33} {V}_{z}^{e}\end{matrix} ) \cdot γ + \\ [ \begin{matrix}( {R}_{31} - {R}_{32} ) {b}_{GL 1} + \\ ( {R}_{31} + {R}_{32} ) {b}_{GL 2}\end{matrix} ] cos ( π / 4 ) + ( \begin{matrix}{Ry}_{31} {V}_{x}^{e} + \\ {Ry}_{32} {V}_{y}^{e} + \\ {Ry}_{33} {V}_{z}^{e}\end{matrix} ) \cdot {d}_{Yaw} + {g}_{z}^{e}\end{matrix}\end{matrix} \qquad ( 7 )$$

When integrating the GL1, GL2 and yaw rate sensors with GPS/INS, the GL1, GL2 and yaw rate bias are augmented into the centralized GPS/INS filter. These biases are modeled as first-order Gauss-Markov processes. The fill dynamic model is expressed in equation (8).

$$[ \begin{matrix}δ \dot{r} \\ δ \dot{v} \\ \dot{ɛ} \\ δ {\dot{b}}^{b} \\ δ {\dot{d}}^{b} \\ \begin{matrix}Δ ∇ \dot{N} \\ δ {\dot{b}}_{GL 1} \\ δ {\dot{b}}_{GL 2} \\ \dot{δ} {d}_{yaw}\end{matrix}\end{matrix} ] = [ \begin{matrix} & & & & & & & & \\ & & & & & & & & \\ & & {F}_{GPS / INS} & & & & & O & \\ & & & & & & & & \\ & & & & & & & & \\ & & & & & 0 & - {β}_{GL 1} & 0 & 0 \\ & & O & & & 0 & 0 & - {β}_{GL 2} & 0 \\ & & & & & 0 & 0 & 0 & - {β}_{Yaw}\end{matrix} ] \cdot [ \begin{matrix}δ r \\ δ v \\ ɛ \\ δ {b}^{b} \\ δ {d}^{b} \\ \begin{matrix}Δ ∇ N \\ δ {b}_{GL 1} \\ δ {b}_{GL 2} \\ δ {d}_{yaw}\end{matrix}\end{matrix} ] + [ \begin{matrix}0 & 0 & 0 & 0 & 0 & 0 & 0 \\ {R}_{b}^{e} & 0 & 0 & 0 & 0 & 0 & 0 \\ 0 & {R}_{b}^{e} & 0 & 0 & 0 & 0 & 0 \\ 0 & 0 & I & 0 & 0 & 0 & 0 \\ 0 & 0 & 0 & I & 0 & 0 & 0 \\ 0 & 0 & 0 & 0 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ] \cdot [ \begin{matrix}{w}_{f} \\ {w}_{w} \\ {w}_{b} \\ {w}_{d} \\ {w}_{GL 1} \\ \begin{matrix}{w}_{GL 2} \\ {ω}_{yaw}\end{matrix}\end{matrix} ] \qquad ( 8 )$$

where δb_{GL1} is the GL1 sensor bias error, δ_{GL2} is the GL2 sensor bias error, and δd_{yaw} is yaw the rate sensor bias error.

The measurement model for the position and velocity updates by the GL1, GL2 and yaw rate sensors is

$${[ \begin{matrix}{r}^{e} \\ {V}^{e}\end{matrix} ]}_{GL / Yaw} + {[ \begin{matrix}0 \\ Δ {V}_{drift}\end{matrix} ]}_{GL / Yaw} = {[ \begin{matrix}{r}^{e} \\ {V}^{e}\end{matrix} ]}_{IMU} + [ \begin{matrix}{R}_{b}^{e} {L}^{b} \\ {\dot{R}}_{b}^{e} {L}^{b}\end{matrix} ] \qquad ( 9 )$$

The design matrix is

$$\qquad ( 10 )$$

$$H = \\ [ \begin{matrix}1 & 0 & 0 & 0 & 0 & 0 & 0 & 0 & 0 & 0 & 0 & 0 & 0 & 0 & 0 & 0 & 0 & 0 & 0 & 0 & 0 \\ 0 & 1 & 0 & 0 & 0 & 0 & 0 & 0 & 0 & 0 & 0 & 0 & 0 & 0 & 0 & 0 & 0 & 0 & 0 & 0 & 0 \\ 0 & 0 & 1 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 0 & 0 & 0 & 0 & 0 & 0 & 0 & 0 & 0 & A 1 & A 2 & A 3 \\ 0 & 0 & 0 & 0 & 1 & 0 & 0 & 0 & 0 & 0 & 0 & 0 & 0 & 0 & 0 & 0 & 0 & 0 & B 1 & B 2 & B 3 \\ 0 & 0 & 0 & 0 & 0 & 1 & 0 & 0 & 0 & 0 & 0 & 0 & 0 & 0 & 0 & 0 & 0 & 0 & C 1 & C 2 & C 3\end{matrix} ]$$

where
A1=(R₁₁−R₁₂)·cos(π/4)·Δt, A2=(R₁₁+R₁₂)·cos(π/4)·Δt, A3=(R_{y11}Vₓ+R_{y12}V_{y}+R_{y13}V_{z})·Δt
B1=(R₂₁−R₂₂)·cos(π/4)·Δt, B2=(R₂₁+R₂₂)·cos(r/4)·Δt, B3=(R_{y21}Vₓ+R_{y22}V_{y}+R_{y23}V_{z})·Δt
C1=(R₃₁−R₃₂)·cos(π/4)·Δt, C2=(R₃₁+R₃₂)·cos(π/4)·Δt, C3=(R_{y31}Vₓ+R_{y32}V_{y}+R_{y33}V_{z})·Δt
Δt is the integration time

Using variance propagation theory, the variance of the specific force in the vehicle frame can be derived from equation (2).

$$\begin{matrix}{σ}_{{f}_{x}^{v}}^{2} = \frac{1}{2} ( {σ}_{GL 1}^{2} + {σ}_{GL 2}^{2} ) & ( 11 ) \\ {σ}_{{f}_{y}^{v}}^{2} = \frac{1}{2} ( {σ}_{GL 1}^{2} + {σ}_{GL 2}^{2} ) & ( 12 )\end{matrix}$$

The velocity variance in the ECEF frame is expressed in equation (13)

$${σ}_{{v}^{e}}^{2} = {σ}_{v 0}^{2} + {R}_{v}^{e} \cdot [ \begin{matrix}{σ}_{{f}_{x}^{v}}^{2} & 0 & 0 \\ 0 & {σ}_{{f}_{y}^{v}}^{2} & 0 \\ 0 & 0 & 1\end{matrix} ] \cdot {( {R}_{v}^{e} )}^{T} \cdot Δ {t}^{2} + ( {R}_{y } γ ) \cdot {σ}_{v 0}^{2} \cdot {( {R}_{y} γ )}^{T} \cdot Δ {t}^{2} + ( {R}_{y} {V}_{0} ) \cdot {σ}_{v 0}^{2} \cdot {( {R}_{y} {V}_{0} )}^{T} \cdot Δ {t}^{2} . \qquad ( 13 )$$

where V₀ is the initial position coming from the integrated output.
The position variance is:

$${σ}_{{r}^{e}}^{2} = {σ}_{r 0}^{2} + {σ}_{{v}^{e}}^{2} \cdot Δ {t}^{2} + \frac{1}{4} {R}_{v}^{e} \cdot [ \begin{matrix}{σ}_{{f}_{x}^{v}}^{2} & 0 & 0 \\ 0 & {σ}_{{f}_{y}^{v}}^{2} & 0 \\ 0 & 0 & 1\end{matrix} ] \cdot {( {R}_{v}^{e} )}^{T} \cdot Δ {t}^{4} + \frac{1}{4} ( {R}_{y} γ ) \cdot {σ}_{v 0}^{2} \cdot {( {R}_{y} γ )}^{T} \cdot Δ {t}^{4} + \frac{1}{4} ( {R}_{y} {V}_{0} ) \cdot {σ}_{v 0}^{2} \cdot {( {R}_{y} {V}_{0} )}^{T} \cdot Δ {t}^{4} \qquad ( 14 )$$

The position and velocity variances with the GL1, GL2 and yaw rate sensor integration strategy is:

$${σ}_{PV}^{2} = [ \begin{matrix}I & I \\ 0 & I\end{matrix} ] \cdot [ \begin{matrix}{σ}_{{r}^{e}}^{2} & 0 \\ 0 & {σ}_{{v}^{e}}^{2}\end{matrix} ] \cdot [ \begin{matrix}I & 0 \\ I & I\end{matrix} ] \qquad ( 15 )$$

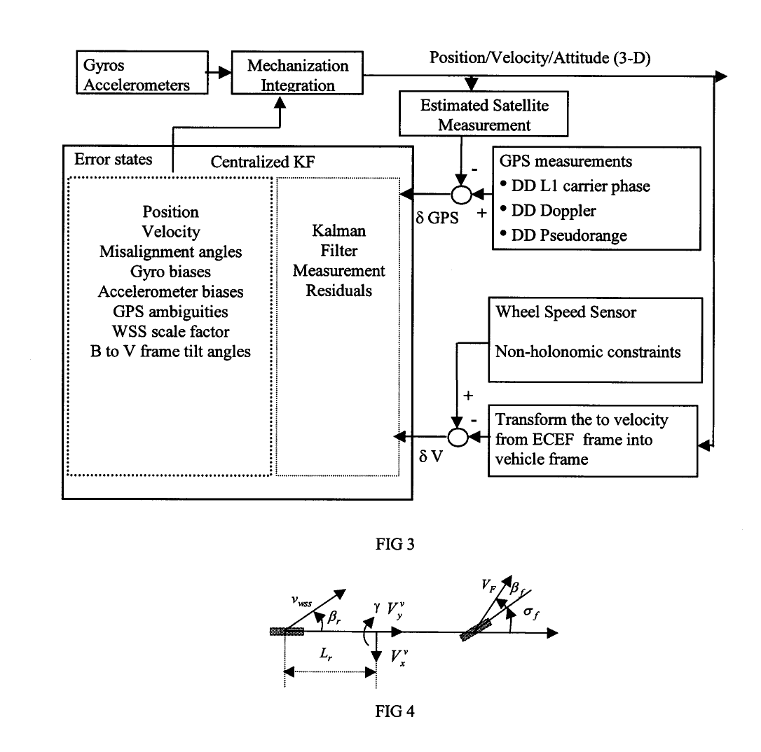

GPS/INS/Wheel Speed Sensor Integration FIG. 3 shows the structure of the GPS/INS/WSS integration strategy. The wheel speed sensor, which may be one or more of any of the driven or non-driven wheels, measures the Y-direction velocity in the vehicle frame. In one embodiment, two non-holonomic constraints are applied to the X and Z directions of the vehicle frame. The non-holonomic constraints imply that the vehicle does not move in the up or transverse directions, which holds in most cases. The wheel speed sensor therefore provides the absolute velocity information to update the centralized Kalman filter. During GPS outages, the non-holonomic constraints as well as the absolute velocity information can constrain the velocity and consequently the position drift of the free-inertial system.

In practical use, tire radius is subject to change, based on load and the driving conditions.

Additionally, the IMU body frame does not always coincide with the vehicle frame. Thus, the scale factor of the wheel speed sensor(s) and the tilt angles between the vehicle and body frames are augmented into the error states of GPS/INS centralized Kalman filter. The dynamic model in equation (1) is accordingly changed to equation (16) below. The Wheel Speed Sensor scale factor and the tilt angles between the b and v frames are modeled as random constants.

$$[ \begin{matrix}δ \dot{r} \\ δ \dot{v} \\ \dot{ɛ} \\ δ {\dot{b}}^{b} \\ δ {\dot{d}}^{b} \\ \begin{matrix}Δ ∇ \dot{N} \\ δ \dot{S} \\ {\dot{ɛ}}_{b - v}\end{matrix}\end{matrix} ] = [ \begin{matrix} & & & & & & & \\ & & & & & & & \\ & & {F}_{GPS / INS} & & & & O & \\ & & & & & & & \\ & & & & & & & \\ & & & & & & & \\ 0 & 0 & 0 & 0 & 0 & 0 & 0 & 0 \\ 0 & 0 & 0 & 0 & 0 & 0 & 0 & 0\end{matrix} ] \cdot [ \begin{matrix}δ r \\ δ v \\ ɛ \\ δ {b}^{b} \\ δ {d}^{b} \\ \begin{matrix}Δ ∇ N \\ δ S \\ {ɛ}_{b - v}\end{matrix}\end{matrix} ] + [ \begin{matrix}0 & 0 & 0 & 0 \\ {R}_{b}^{e} & 0 & 0 & 0 \\ 0 & {R}_{b}^{e} & 0 & 0 \\ 0 & 0 & I & 0 \\ 0 & 0 & 0 & I \\ 0 & 0 & 0 & 0 \\ 0 & 0 & 0 & 0 \\ 0 & 0 & 0 & 0\end{matrix} ] \cdot [ \begin{matrix}{w}_{f} \\ {w}_{w} \\ {w}_{b} \\ {w}_{d}\end{matrix} ] \qquad ( 16 )$$

where F_{GPS/INS/WSS} is the dynamic matrix for GPS/INS/WSS integration strategy, δS is the Wheel Speed Sensor scale factor error state, and ε_{b-v}=[δα δβ δα]^{T} is the error vector of the tilt angles between the body frame and the vehicle frame corresponding to the X, Y and Z axes respectively.

Since the wheel speed is measured in the vehicle frame, and the velocities in GPS/INS system are parameterized in the e-frame, the WSS update can be either carried out in the e-frame by transforming the WSS measurement into the e-frame or carried out in the v-frame by transforming the GPS/INS integrated velocities into the v frame. In the v-frame, the measurement equation is expressed in equation (17) with two non-holonomic constraints being applied into the X and Z axes of the vehicle frame.

$$[ \begin{matrix}0 \\ S \cdot {v}_{WSS} \\ 0\end{matrix} ] = {R}_{b}^{v} \cdot {( {R}_{b}^{e} )}^{T} \cdot {v}^{e} \qquad ( 17 )$$

where v_{WSS} is the Wheel Speed Sensor measurement, S is the Wheel Speed Sensor scale factor, and R_{b}^{v} is the direction cosine matrix between the b frame and v frames calculated by the following:

R_{b}^{v}=R₃(γ)·R₁(α)·R₂(β) (18)

where α, β, γ are the tilt angles between the b and v frames with respect to the X, Y and Z axes, respectively.

The measurement model in the extended Kalman filter is generally expressed by equation (19)

Z=H·δx+ωₘ (19)

where H is the design matrix, ωₘ is the measurement noise and Z is the measurement residual.

By linearizing equation (17), the measurement residual is expressed as in equation (20)

$$Z = [ \begin{matrix}0 \\ S \cdot {v}_{WSS} \\ 0\end{matrix} ] - {R}_{b}^{v} \cdot {( {R}_{b}^{e} )}^{T} \cdot {v}^{e} = [ \begin{matrix}0 \\ S \cdot {v}_{WSS} \\ 0\end{matrix} ] - {v}^{v} \qquad ( 20 )$$

where v^{v} is the integrated velocity expressed in the v frame.

The design matrix is expressed by a matrix in equation (21).

H=[O_{3×3}R_{b}^{v}·(R_{b}^{e})^{T}R_{b}^{v}·(R_{b}^{e})^{T}·V^{E}O_{3×3}O_{3×3}O_{AR×AR}−v_{WSS}V^{V}] (21)

where V^{E} is the skew symmetric matrix of the integrated velocity in ECEF frame v^{e}, V^{V} is the skew symmetric matrix of the integrated velocity expressed in vehicle frame v^{v}, O is a zero matrix with the subscripted dimensions and AR is the number of float ambiguities. AR is equal to zero when all the ambiguities are fixed.

### The Detection and Alleviation of Violation of Non-Holonomic Constraints in GPS/INS/WSS Using G Sensors and YAW Rate Sensor

As shown in Equation (17), GPS/INS/WSS integration strategy applies two non-holonomic constraints in the lateral and vertical directions. The non-holonomic constraints are valid only when the vehicle operates on the flat road and no side slip occurs, and are violated when the vehicle runs off-road or on a bumpy road. Using the two G sensors and the yaw rate sensor, one can detect and alleviate the violation of the non-holonomic constraints.

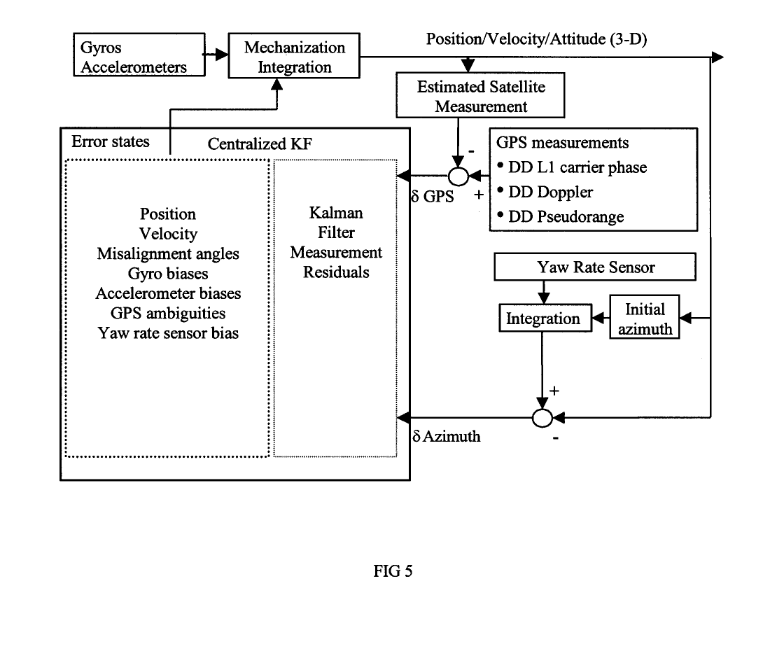

The violation of the non-holonomic constraints is always accompanied by a larger side slip angle. FIG. 4 defines the rear and front side slip angles with respect to the bicycle model. The rear wheel side slip angle can be computed in Equation (22) (Ray, 1995) from the lateral and longitudinal velocities derived from Equation (3) with respect to G sensors and yaw rate sensor.

$${β}_{r} = {tan}^{- 1} [ \frac{{V}_{x}^{v} - {L}_{r} \cdot γ}{{V}_{y}^{v}} ] \qquad ( 22 )$$

where Pr is the rear wheel side slip angle. Lᵣ is the distance between the G sensors/Yaw rate sensor and the rear wheel axis. Vₓ^{v} and V_{y}^{v} are the lateral and longitudinal velocities in the vehicle frame respectively, computed from the G sensors and yaw rate sensor.

The computed side slip angle provides a way to detect the violation of the non-holonomic constraints. When the side slip angle is smaller than a specified threshold, the non-holonomic constraints are applied as Equation (17). By contrast, when the side slip angle is larger than the threshold, thus indicating the non-holonomic constraints are violated, the lateral non-holonomic constraints of Equation (17) can be replaced either by the velocity computed from the G sensors and yaw rate sensor or by the decomposition of the wheel speed sensor measurement with that of Equation (23),

$${V}_{WSS} = [ \begin{matrix}{V}_{x}^{v} \\ {v}_{wss} \\ 0\end{matrix} ] or {V}_{WSS} = [ \begin{matrix}{v}_{wss} \cdot sin ( {β}_{r} ) \\ {v}_{wss} \cdot cos ( {β}_{r} ) \\ 0\end{matrix} ] \qquad ( 23 )$$

### GPS/INS/YAW Rate Sensor Integration Strategy and Algorithm

FIG. 5 shows a block diagram of the integration of the GPS, INS and the yaw rate sensor (YRS). By integrating the output of the yaw rate sensor, the change in the azimuth angle can be obtained. The initial value of the yaw rate mechanization equation comes from the integrated azimuth output. This integrated azimuth angle can therefore be used as a measurement to update the centralized GPS/INS filter.

Using the trapezoid method (Jekeli, 2000), the measurement from the YRS is integrated to derive the azimuth angle with its initial value being provided by the azimuth output of the integrated system.

The measurement equation is equation (24)

Z_{Azimuth}=α+δd_{Yaw}Δt (24)

where Z_{azimuth} is the integration output from the YRS, α is the azimuth output from the GPS/INS integrated system, and Åt is the integration interval.

Equation (25) shows the dynamic model by augmenting the Yaw Rate Sensor bias.

$$[ \begin{matrix}δ \dot{r} \\ δ \dot{v} \\ \dot{ɛ} \\ δ \dot{{b}^{b}} \\ δ \dot{{d}^{b}} \\ Δ ∇ \dot{N} \\ δ {\dot{d}}_{yaw}\end{matrix} ] = [ \begin{matrix} & & & & & & 0 \\ & & & & & & 0 \\ & & & {F}_{GPS / INS} & & & 0 \\ & & & & & & 0 \\ & & & & & & 0 \\ & & & & & & 0 \\ 0 & 0 & 0 & 0 & 0 & 0 & - {β}_{Yaw}\end{matrix} ] \cdot [ \begin{matrix}δ r \\ δ v \\ ɛ \\ δ {b}^{b} \\ δ {d}^{b} \\ Δ ∇ N \\ δ {d}_{yaw}\end{matrix} ] + [ \begin{matrix}0 & 0 & 0 & 0 & 0 \\ {R}_{b}^{e} & 0 & 0 & 0 & 0 \\ 0 & {R}_{b}^{e} & 0 & 0 & 0 \\ 0 & 0 & I & 0 & 0 \\ 0 & 0 & 0 & I & 0 \\ 0 & 0 & 0 & 0 & 0 \\ 0 & 0 & 0 & 0 & 1\end{matrix} ] [ \begin{matrix}{w}_{f} \\ {w}_{w} \\ {w}_{b} \\ {w}_{d} \\ {w}_{yaw}\end{matrix} ] \qquad ( 25 )$$

where δd_{yaw} is the error state of the YRS bias, β_{Yaw} is the inverse of the time constant, and ω_{yaw} is the driving noise of the YRS bias.

The design matrix is a matrix expressed in equation (26), which is derived from the measurement equation (24).

H=[O_{3×3}O_{3×3}(Rₑ^{l})_{3rd row}O_{3×3}O_{3×3}O_{AR×AR}Δt] (26)

where Rₑ^{l} is the direction cosine matrix between the e frame and the local level frame. Since the estimated error states are defined in ECEF frame, and the azimuth angle is related to the local level frame, the third row in the Rₑ^{l} matrix appears in the design matrix.

In this integration strategy, the YRS provides the azimuth update to the centralized filter. Since only the relative azimuth is computed from the YRS, the performance of this integration strategy has a close relationship with the measurement accuracy of the YRS.

### GPS/INS/Steering Angle Sensor Integration Strategy and Algorithm

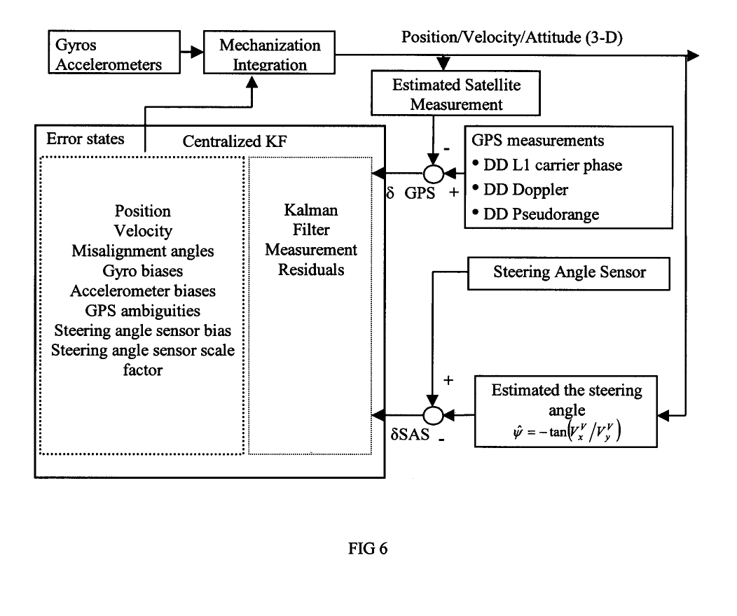

The basic idea of integrating the steering angle sensor with GPS/INS is to compute the estimated steering angle from the integrated velocity output in the vehicle frame, and then employ the steering angle sensor measurement to update the GPS/INS Kalman filter, as shown in FIG. 6.

In the dynamic model of the GPS/INS/Steering angle sensor integrated system, the scale factor and the bias of the steering angle sensor are augmented into the error states of the GPS/INS Kalman filter. The scale factor and steering angle sensor bias are all modeled as random constants. The dynamic model is therefore expressed in equation (27).

$$[ \begin{matrix}δ \dot{r} \\ δ \dot{v} \\ \dot{ɛ} \\ δ {\dot{b}}^{b} \\ δ {\dot{d}}^{b} \\ Δ ∇ \dot{N} \\ δ {\dot{S}}_{SAS} \\ δ {\dot{b}}_{SAS}\end{matrix} ] = [ \begin{matrix} & & & & & & & & \\ & & & & & & & & \\ & & & {F}_{GPS / INS} & & & & & \\ & & & & & & & O & \\ & & & & & & & & \\ & & & & & & & & \\ & & & & & & & & \\ 0 & 0 & 0 & 0 & 0 & 0 & 0 & 0 & 0 \\ 0 & 0 & 0 & 0 & 0 & 0 & 0 & 0 & 0\end{matrix} ] \cdot [ \begin{matrix}δ r \\ δ v \\ ɛ \\ δ {b}^{b} \\ δ {d}^{b} \\ Δ Δ N \\ δ {S}_{SAS} \\ δ {b}_{SAS}\end{matrix} ] + [ \begin{matrix}0 & 0 & 0 & 0 \\ {R}_{b}^{e} & 0 & 0 & 0 \\ 0 & {R}_{b}^{e} & 0 & 0 \\ 0 & 0 & I & 0 \\ 0 & 0 & 0 & I \\ 0 & 0 & 0 & 0 \\ 0 & 0 & 0 & 0 \\ 0 & 0 & 0 & 0\end{matrix} ] \cdot [ \begin{matrix}{w}_{f} \\ {w}_{w} \\ {w}_{b} \\ {w}_{d}\end{matrix} ] \qquad ( 27 )$$

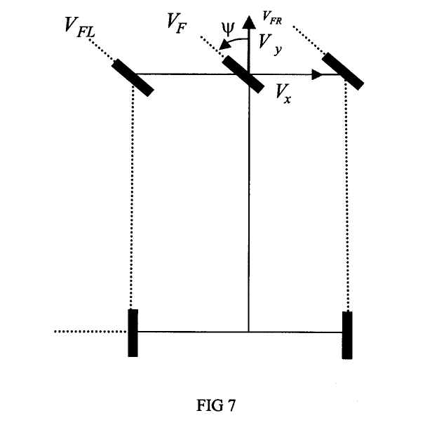

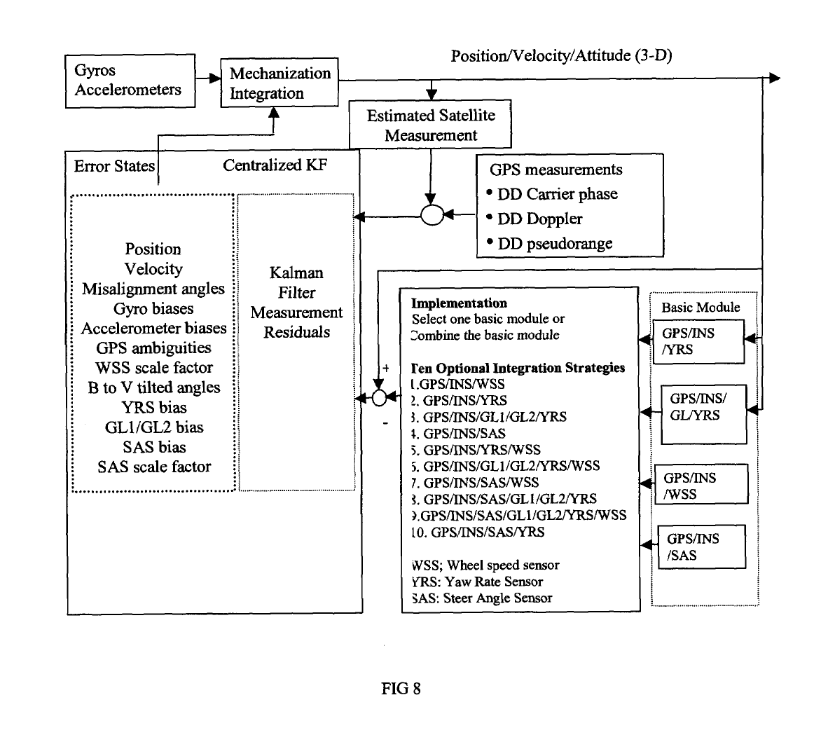

If assuming the sideslip of the front tire is zero, the steering angle can be estimated from the velocity in the vehicle frame as shown in FIG. 7:

$$\hat{ψ} = - {tan}^{- 1} ( \frac{{V}_{x}^{v}}{{V}_{y}^{v}} ) \qquad ( 28 )$$

The opposite sign in equation (28) is due to the definition of the vehicle frame as Right-Front-Up, while a positive steering angle is corresponding to a left turn which is contrary in sign to the value calculated from the estimated velocity. FIG. 7 shows this relationship.

As shown in equation (29), the velocity in the vehicle frame is obtained by transforming the velocity into the ECEF frame

$$[ \begin{matrix}{V}_{x}^{v} \\ {V}_{y}^{v} \\ {V}_{z}^{v}\end{matrix} ] = {( {R}_{v}^{e} )}^{T} \cdot [ \begin{matrix}{V}_{x}^{e} \\ {V}_{y}^{e} \\ {V}_{z}^{e}\end{matrix} ] \\ Assume {( {R}_{v}^{e} )}^{T} = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] \qquad ( 29 )$$

thus

Vₓ^{v}=R₁₁·Vₓ^{e}+R₁₂·V_{y}^{e}+R₁₃·V_{z}^{e} (30)

V_{y}^{v}=R₂₁·Vₓ^{e}+R₂₂·V_{y}^{e}+R₂₃·V_{z}^{e} (31)

Substituting equations (30) and (31) into equation (28) gives

$$\hat{ψ} = - {tan}^{- 1} ( \frac{{V}_{x}^{v}}{{V}_{y}^{v}} ) = - {tan}^{- 1} ( \frac{{R}_{11} \cdot {V}_{x}^{e} + {R}_{12} \cdot {V}_{y}^{e} + {R}_{13} \cdot {V}_{z}^{e}}{{R}_{21} \cdot {V}_{x}^{e} + {R}_{22} \cdot {V}_{y}^{e} + {R}_{23} \cdot {V}_{z}^{e}} ) \qquad ( 32 )$$

The measurement model for the GPS/INS/Steering angle sensor is shown in equation (33)

$${S}_{SAS} ( ψ - {d}_{SAS} ) = - {tan}^{- 1} ( \frac{{R}_{11} \cdot {V}_{x}^{e} + {R}_{12} \cdot {V}_{y}^{e} + {R}_{13} \cdot {V}_{z}^{e}}{{R}_{21} \cdot {V}_{x}^{e} + {R}_{22} \cdot {V}_{y}^{e} + {R}_{23} \cdot {V}_{z}^{e}} ) + w \qquad ( 33 )$$

where
S_{SAS} is the scale factor of the steering angle sensor,
d_{SAS} is the bias of the steering angle sensor, and
ψ is the steering angle sensor measurement.

By linearizing equation (31), the linearized measurement model is shown in equation (34)

$$δψ = - \frac{{R}_{11} \cdot {V}_{y}^{v} - {R}_{21} \cdot {V}_{x}^{v}}{{( {V}_{x}^{v} )}^{2} + {( {V}_{y}^{v} )}^{2}} δ {V}_{x}^{e} - \frac{{R}_{12} \cdot {V}_{y}^{v} - {R}_{22} \cdot {V}_{x}^{v}}{{( {V}_{x}^{v} )}^{2} + {( {V}_{y}^{v} )}^{2}} δ {V}_{y}^{e} - \frac{{R}_{13} \cdot {V}_{y}^{v} - {R}_{23} \cdot {V}_{x}^{v}}{{( {V}_{x}^{v} )}^{2} + {( {V}_{y}^{v} )}^{2}} δ {V}_{z}^{e} - ( ψ - {d}_{SAS} ) δ {S}_{SAS} + {S}_{SAS} δ {d}_{SAS} \qquad ( 34 )$$

Therefore, the design matrix is given in equation (35)

$$H = [ \begin{matrix}{O}_{3 \times 3} - \frac{{R}_{11} \cdot {V}_{y}^{v} - {R}_{21} \cdot {V}_{x}^{v}}{{( {V}_{x}^{v} )}^{2} + {( {V}_{y}^{v} )}^{2}} - \frac{{R}_{12} \cdot {V}_{y}^{v} - {R}_{22} \cdot {V}_{x}^{v}}{{( {V}_{x}^{v} )}^{2} + {( {V}_{y}^{v} )}^{2}} - \\ \frac{{R}_{13} \cdot {V}_{y}^{v} - {R}_{23} \cdot {V}_{x}^{v}}{{( {V}_{x}^{v} )}^{2} + {( {V}_{y}^{v} )}^{2}} \begin{matrix}{O}_{3 \times 3} & {O}_{3 \times 3} & {O}_{3 \times 3} & - ( ψ - {d}_{SAS} ) & {S}_{SAS} & 0\end{matrix}\end{matrix} ] \qquad ( 35 )$$

### Combination Integration Strategies

Based on the integration strategies described above, additional integration strategies can be derived from these basic cases. The combined integration strategies include:
GPS/INS/YRS/WSS
GPS/INS/GL1/GL2/YRS/WSS
GPS/INS/SAS/GL1/GL2/YRS
GPS/INS/SAS/GL1/GL2/YRS/WSS
GPS/INS/SAS/YRS

FIG. 8 demonstrates the structure of available integration strategies. Four basic modules—GPS/INS/WSS, GPS/INS/YRS, GPS/INS/GL/YRS and GPS/INS/SAS—provide redundant navigation and positioning information, such as velocity, azimuth angle, 2-D position and velocity, as well as steering angle to the centralized GPS/INS Kalman filter for more precise navigation and positioning. The basic modules as well as their combinations generate multiple optional integration strategies.

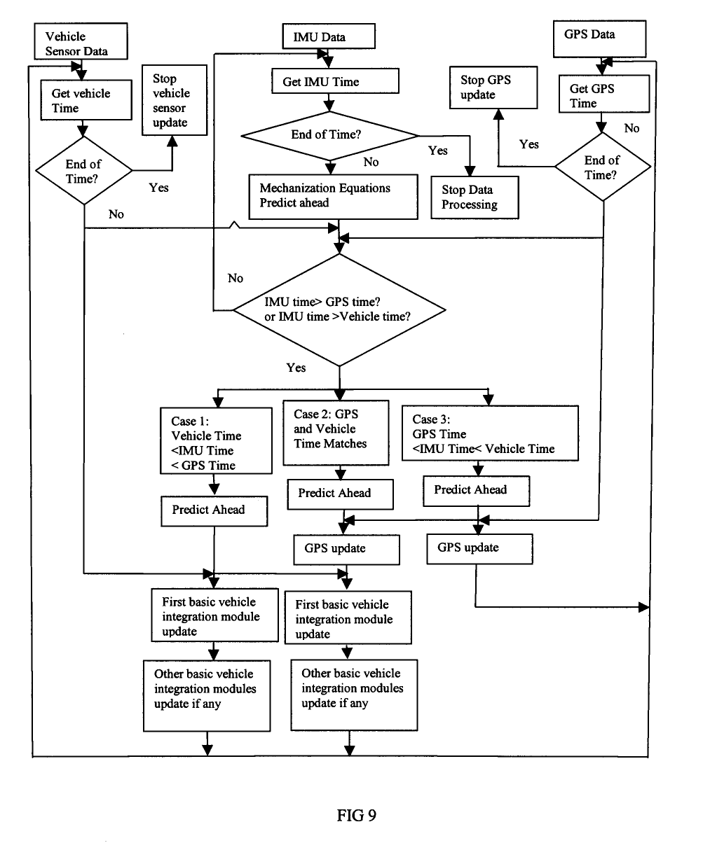

FIG. 9 shows a flow chart of the implementation of the various integration strategies. The GPS or on-board vehicle sensor update is started by the time sequence. When the IMU time is less than the GPS and the vehicle sensor times, no update is done and only INS mechanization and prediction is performed. When the IMU time is greater than GPS or vehicle sensor times, three possibilities are available for updating: a GPS update, a vehicle sensor update, or a GPS/vehicle sensor update. The vehicle sensor update may be undertaken by one basic integration module followed by the other if a combined integration strategy is chosen.

In one embodiment, the steering angle sensor (SAS) integration may be augmented by wheel speed sensor (WSS) data to provide an update to the GPS/INS filter. This integration may be achieved by sequentially integrating the SAS by using the basic SAS module and the WSS module described above. Alternatively, the WSS output may be combined with the SAS output to provide a velocity update to the GPS/INS filter.

The velocity of the vehicle, as depicted in FIG. 7, is derived in equation (36)

$${V}_{x}^{v} = - \frac{1}{2} ( {V}_{FR} + {V}_{FL} ) \cdot sin ( ψ ) = - {V}_{WSS} \cdot sin ( ψ ) \\ {V}_{y}^{v} = \frac{1}{2} ( {V}_{FR} + {V}_{FL} ) \cdot cos ( ψ ) = {V}_{WSS} \cdot cos ( ψ ) \qquad ( 36 )$$

As detailed above, by taking the scaling factor of the wheel speed sensor, and the misalignment angle between the vehicle frame and body frame into account, the velocity in the vehicle frame is transformed into e-frame through equation (37).

$$[ \begin{matrix}{V}_{x}^{e} \\ {V}_{y}^{e} \\ {V}_{z}^{e}\end{matrix} ] = S \cdot {R}_{v}^{e} \cdot [ \begin{matrix}- {V}_{WSS} \cdot sin ( ψ ) \\ {V}_{WSS} \cdot cos ( ψ ) \\ 0\end{matrix} ] \qquad ( 37 )$$

The velocity in the e-frame thus obtained can be used in a velocity update in like manner as described above in relation to the GPS/INS/WSS integration module. However, the measurement covariance matrix in this strategy is different. The revised covariance matrix is computed by equation (38):

$${σ}_{{V}^{e}}^{2} = S \cdot {R}_{v}^{e} \cdot [ \begin{matrix}{σ}_{{V}_{WSS}}^{2} {sin}^{2} ( ψ ) + {V}_{WSS}^{2} \cdot {cos}^{2} ( ψ ) \cdot {σ}_{ψ}^{2} & 0 & 0 \\ 0 & {σ}_{{V}_{WSS}}^{2} {cos}^{2} ( ψ ) + {V}_{WSS}^{2} \cdot {sin}^{2} ( ψ ) \cdot {σ}_{ψ}^{2} & 0 \\ 0 & 0 & {0.66}^{2}\end{matrix} ] \cdot {( S \cdot {R}_{v}^{e} )}^{T} \qquad ( 38 )$$

### REFERENCES

The following references are incorporated herein as if reproduced in their entirety.
Dissanayake, G., Sukkarieh, S., Nebot, E. and DurrantWhyte, H. (2001). The aiding of a Low Cost Strapdown Inertial Measurement Unit suing Vehicle Model Constraints for Land vehicle Applications. IEEE Transactions on Robotics and Automation, Vol. 17, No. 5, 2001, pp. 731-747.
Hong, S. K. Fuzzy logic based closed-loop strapdown attitude system for unmanned aerial vehicle (UAV). Journal of sensors and actuators. 107 (2003), pp 109-118
Jekli, C. (2000) Inertial Navigation Systems with Geodetic Applications. Walter de, Gruyter, New York, N.Y., USA.
Gao, J., Petovello, M. and Cannon, M. E. Development of Precise GPS/INS/Wheel Speed Sensor/Yaw Rate Sensor Integrated System. Proceeding of ION NTM 2006, (January, Monterey, Calif.)
Petovello, M. G. (2003). Real-Time Integration of Tactical Grade IMU and GPS for High-Accuracy Positioning and Navigation. PhD Thesis, UCGE Report #20116, Department of Geomatics Engineering, The University of Calgary.
Ray, L. R. (1995). Nonlinear State and Tire Force Estimation for Advanced Vehicle Control IEEE Transactions on Control System Technology, Vol. 3, No. 1, 1995, pp. 117-124.
Scherzinger, B. M. (2002). Robust Positioning with Single Frequency Inertially Aided RTK. Proceedings of ION NTM 2002. pp. 911-917. Institute of Navigation, Alexandria, Va., USA.
Zhang, H. T., Petovello, M. G. and Cannon, M. E. (2005) Performance Comparison of Kinematic GPS Integrated with Different Tactical Level IMUs. Proceedings of ION NTM 2005, (January, San Diego, Calif.), pp. 243-254.

What is claimed is:

1. A method of estimating one or more of the velocity, position, or attitude of a vehicle equipped with a GNSS receiver, an inertial navigation system (INS), a vehicle sensor comprising a steering angle sensor and optionally a wheel speed sensor, a yaw rate sensor, and/or at least two G sensors, comprising the steps of:
(a) setting one or more of an initial velocity, position or attitude;
(b) periodically obtaining INS data, vehicle sensor data, and if GNSS data is available, GNSS data from the GNSS receiver;
(c) in a recursive estimation filter, integrating all available data and estimating one or more error states including one or more of position error, velocity error, attitude error, IMU sensor error, vehicle sensor error and GNSS ambiguity; and
(d) updating one or more of the vehicle position, velocity or attitude.

2. The method of claim 1 wherein each of vehicle position, velocity and attitude is set in step (a) and updated in step (d).

3. The method of claim 1 wherein the recursive estimation filter is a Kalman filter.

4. The method of claim 3 wherein the Kalman filter is a centralized master Kalman filter.

5. The method of claim 1 wherein the GNSS receiver is a GPS receiver.

6. The method of claim 1 wherein the recursive estimation filter comprises two or more federated Kalman filters.

7. The method of claim 1 wherein the integration step comprises the step of integrating steering angle data which provides the tire angle relative to its neutral position, and one or more of the group comprising:
(a) integrating velocity data derived from the at least one wheel speed sensor;
(b) integrating azimuth angle data derived from the yaw rate sensor;
(c) integrating position and velocity data derived from the at least two G sensors and the yaw rate sensor.

8. The method of claim 1 further comprising the step of detecting and alleviating violation of non-holonomic constraints if sideslip is detected.

9. A system for estimating the velocity, position, or attitude of a vehicle equipped with a GNSS receiver, an inertial navigation system (INS), a vehicle sensor comprising a steering angle sensor and optionally a wheel speed sensor, a yaw rate sensor, at least two G sensors, comprising:
(a) means for setting one or more of an initial velocity, position or attitude;
(b) means for periodically obtaining INS data, vehicle sensor data, and if GNSS data is available, GNSS data from the GNSS receiver;
(c) a recursive estimation filter for integrating all available data and estimating one or more error states including one or more of position error, velocity error, attitude error, IMU sensor error, vehicle sensor error and GNSS ambiguity; and
(d) means for updating one or more of the vehicle position, velocity or attitude.

10. The system of claim 9 wherein the GNSS receiver is a GPS receiver.

11. The system of claim 9 wherein the recursive estimation filter comprises a module for integrating steering angle data which provides the tire angle relative to its neutral position, and one or more of the group comprising:
(a) a module for integrating velocity data derived from the at least one wheel speed sensor;
(b) a module for integrating azimuth angle data derived from the yaw rate sensor; and
(c) a module for integrating position and velocity data derived from the at least two G sensors and the yaw rate sensor.

12. The system of claim 9 further comprising means for detecting sideslip and means for detecting and alleviating violation of non-holonomic constraints.
